(19) United States
(12) Patent Application Publication
(10) Pub. No.: US 2015/0019272 A1
(43) Pub. Date: Jan. 15, 2015

(54) ONLINE VACATION RENTAL BOOKING SYSTEM

(71) Applicant: Vakast Inc., Newport Beach, CA (US)

(72) Inventor: Huan Truong, Newport Beach, CA (US)

(21) Appl. No.: 13/940,124

(22) Filed: Jul. 11, 2013

(51) Int. Cl. G06Q 50/14; G06Q 10/02

(52) U.S. Cl. CPC G06Q 50/14; G06Q 10/02
USPC 705/5

(57) ABSTRACT

The present invention provides, in at least one embodiment, an online vacation rental booking system having a plurality of cells comprising rows and columns, the rows having a number of bedrooms and the columns having a period of time. In one embodiment, a first cell is tied to a particular number of bedrooms for the vacation rental and tied to a particular month. The first cell illustrates the number of vacation rentals available and the average nightly price of the available vacation rentals. Embodiments provide significant help to the vacation rental traveler in deciding which month to travel, which city to travel to, and how to easily find a number of bedrooms large enough for the traveler's family.

### BACKGROUND OF THE INVENTION

1. Field of Invention

The invention relates generally to booking systems, and more particularly, to an online vacation rental booking system.

2. Description of Related Art

Travel bookings are one of the largest components of e-commerce. Online travel websites help users find and book cheap flights, hotels, vacations, rental cars, bed and breakfasts, cruise lines, etc. Many websites include some sort of search engine technology to look for bookings within a certain timeframe, service class, geographic location, or price range.

One type of travel booking is vacation rentals. A vacation rental is the renting out of a place on a temporary basis to tourists as an alternative to a hotel, motel, or hostel. Vacation rentals are also referred to as vacation homes, villas, townhouses, condominiums, furnished apartments, houses, etc. Vacation rentals have long been a popular lodging option in Europe and Canada, and are increasingly becoming popular across the rest of the world.

Typically, major differences exist between a traveler that is planning to stay in a vacation rental and a traveler that is planning to stay in a hotel. A first major difference is the timing of the planning and stay, affecting the timeframe for the stay. The vacation rental traveler typically plans ahead more, has a longer stay planned, and has a more flexible vacation schedule. For example, if a traveler is just passing through town for one night and looking for lodging, often the most convenient option is a hotel. By contrast, a vacation rental is the best option for a traveler who has several months to plan his vacation from work or school and wants to stay for many days. Vacation rentals are usually less expensive, more spacious, closer to the local non-tourist cultural spots, and often have amenities only found in the more expensive hotels.

Another major difference between vacation rentals and hotels is the size of the lodging desired, affecting the number of bedrooms desired. Often times vacation rentals are better suited for larger groups, such as a family, requiring a specific number of bedrooms. If a single traveler is going on a trip, often the most convenient option is a hotel. By contrast, a person traveling with his family, pets, or a large group, often the best option is a vacation rental. Vacation rentals are more likely to feel like a home away from home. Vacation rentals can have many bedrooms and high end amenities such as a private pool or kitchen.

A problem with conventional vacation rental bookings is that it is challenging for a traveler having flexibility in travel times but not in the size of his group. Often times, the vacation rental traveler will plan his vacation several months in advance, look for which city or country to visit, look for which month to travel, and look for places that accommodate his entire family. When a traveler is planning his vacation from work or during summer break, often times he has a group size and trip length that makes hotel stays undesirable.

Conventional booking systems exist to book travel online. For example, U.S. Pat. Pub. No. 2010/0293011 to Lebreton is directed to a method of generating an offer for resources, such as a hotel room, which meets a customer request and satisfies at least one customer preference. In one embodiment, Lebreton illustrates a table having a one day period of time in the six columns (i.e., January 1st thru 6th) and six different hotels in the six rows (i.e., hotel 1, hotel 2, hotel 3, hotel 4, hotel 5, and hotel 6). Each cell within the table shows the hotel's availability and price for that specific day. This enables the traveler to see if one hotel, or a mixture of hotels, is available for the entire stay.

However, Lebreton falls short in that it does not help a traveler who has flexibility in terms of which month to travel, which city to travel to, and is looking for a specific or minimum number of bedrooms.

### SUMMARY OF THE INVENTION

The present invention provides, in at least one embodiment, an online vacation rental booking system having a plurality of cells comprising rows and columns, the rows having a number of bedrooms and the columns having a period of time. In one embodiment, a first cell is tied to a particular number of bedrooms for the vacation rental and tied to a particular month. The first cell illustrates the number of vacation rentals available and the average nightly price of the available vacation rentals. Embodiments provide significant help to the vacation rental traveler in deciding which month to travel, which city to travel to, and how to easily find a number of bedrooms large enough for the traveler's family.

In one embodiment, a system comprises: a search engine, the search engine searching a vacation rental database based on a location and a time frame; an initial plurality of cells comprising rows and columns, wherein the initial plurality of cells comprising a number of bedrooms in the rows or columns and a period of time in the rows or columns, wherein the period of time per row or column is greater than one day; a first cell in the initial plurality of cells, the first cell based on a first number of bedrooms and a first period of time, wherein the first cell comprises a first price corresponding to one or more vacation rental properties in the first cell; and a second cell in the plurality of cells, the second cell based on a second number of bedrooms and a second period of time, wherein the second cell comprises a second price corresponding to one or more vacation rental properties in the second cell, wherein the second cell comprises a different number of bedrooms or a different period of time than the first cell.

In another embodiment, a method comprises: receiving a location to search for vacation rentals in a search engine; receiving a time frame to search for vacation rentals in the search engine; searching the search engine; displaying a first cell in a plurality of cells having rows and columns, the first cell based on a first number of bedrooms and a first period of time greater than one day, wherein the first cell comprises a first price corresponding to one or more vacation rental properties in the first cell; and displaying a second cell in the plurality of cells, the second cell based on a second number of bedrooms and a second period of time greater than one day, wherein the second cell comprises a second price corresponding to one or more vacation rental properties in the second cell, wherein the second cell comprising a different number of bedrooms or a different period of time than the first cell.

An advantage of the present invention is that the prices and availabilities within the plurality of cells quickly and conveniently provide significant help to the traveler in deciding which month to travel and which city to travel to. The typical vacation traveler who has more flexibility in terms of when and where to travel, but less flexibility in the number of travelers. Embodiments of the present invention utilize this flexibility to help the traveler find a destination and travel time that fits their budget, as lodging and travel distance are some of larger vacation costs. For example, a vacation rental traveler may select a particular country or travel during a particular month based on the cost.

Another advantage of the present invention is that helps a typical vacation traveler, who typically has less flexibility in the number of rooms, such as when the whole family or a group of families is traveling together. Embodiments of the present invention provide significant convenience and quicker searching in finding the price and availability of these vacation rentals.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a monthly grid view of a system according to an embodiment of the invention;

FIG. 2 illustrates a weekly grid view of the system according to an embodiment of the invention;

FIG. 3 illustrates a drilling feature of the system according to an embodiment of the invention;

FIG. 4 illustrates a day matching feature of the system according to an embodiment of the invention; and

FIG. 5 illustrates the process of using the system according to an embodiment of the invention.

### DETAILED DESCRIPTION OF EMBODIMENTS

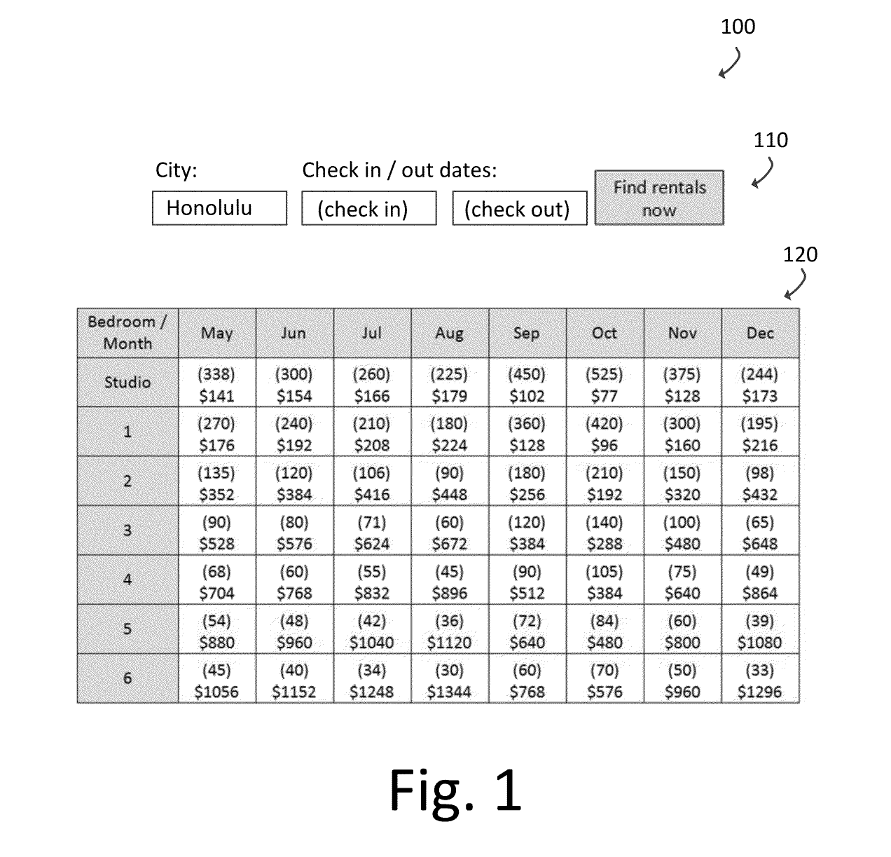

Further features and advantages of the invention, as well as the structure and operation of various embodiments of the invention, are described in detail below with reference to the accompanying FIGS. 1-5, wherein like reference numerals refer to like elements. Although the present invention outputs a grid display that illustrates up to six bedrooms, more or less bedrooms could be illustrated without departing from the invention. Additionally, although the search engine initially outputs a month based view prior to a week based view, one of ordinary skill in the art readily appreciates that the present invention could output a week based view first instead.

The present invention provides, in at least one embodiment, a smarter search engine for vacation rentals to output a unique grid display. In one embodiment, a method and system aggregates rental properties and provides rental availability and its nightly average rate for a vacation rental search engine. The search result is displayed via graphical grid interface that includes a monthly/weekly timeline at the horizontal axis and bedroom sizes at the vertical axis. Available units and average nightly rates are display within each cell grid.

FIG. 1 illustrates a monthly grid view of a system 100 according to an embodiment of the invention. The system 100 includes a search engine 110 and a grid of cells 120. The system 100 provides a more convenient and flexible way to search for and book vacation rentals online. The system 100 can also include a geographic map (not shown) of the desired city with markers representing the location of the available vacation rentals.

The search engine 110 allows a traveler to search based on location and time. As illustrated, the search engine 110 provides a field for a city, fields for check in and check out dates, and a search button to find rentals now. The search engine searches a vacation rental database based on the desired location and time frame. One with skill in the art could design a different arrangement for the search engine 110 without departing from the scope of the invention. For example, the location could be a field for a zip code, county, state, country, etc.

The grid of cells 120 (e.g., monthly grid view, initial plurality of cells, etc.) displays a monthly grid view of the vacation rentals in the desired location (e.g., Honolulu) and months surrounding the desired check in and check out dates. Each of the cells is based on a number of bedrooms in a particular row and a month in a particular column.

For example, the cell in the upper left hand corner indicates that there are 338 Honolulu studios available sometime during the month of May, and the average nightly price of these available studios is $141. If the traveler is willing to delay his vacation until a non-summer month, such as October, the selection increases to 525 available studios and the average nightly price drops down to $77. As such, at a glance, a traveler can conveniently see the availability and prices for different months and bedrooms.

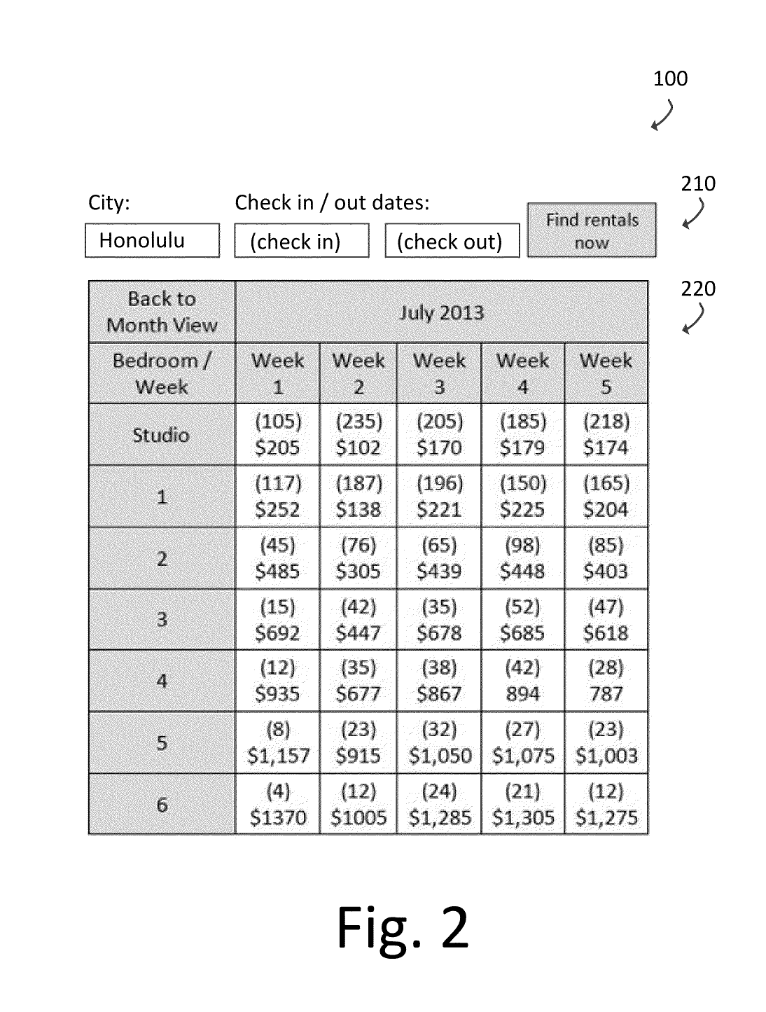

FIG. 2 illustrates a weekly grid view of the system 100 according to an embodiment of the invention. The system 100 includes a search engine 210 and a grid of cells 220. The search engine 210 can be the same as the search engine 110 described in FIG. 1. The system 100 can also include individual listings (not shown) of the vacation rentals available for the desired city and a profile picture for each.

The grid of cells 220 (e.g., weekly grid view, subsequent plurality of cells, etc.) provide a weekly display of the rentals in the desired location (e.g., Honolulu) and the weeks surrounding the desired check in and check out dates. Each cell is based on a number of bedrooms in that particular row and based on a week in that particular column.

For example, the cell in the upper left hand corner indicates that there are 105 Honolulu studios available sometime during the first week of July, and the average nightly price during the first week is $205. If the traveler is willing to delay his vacation until after the 4th of July, the second week of July has significantly more availability and lower prices, both of which may be desirable to a flexible traveler.

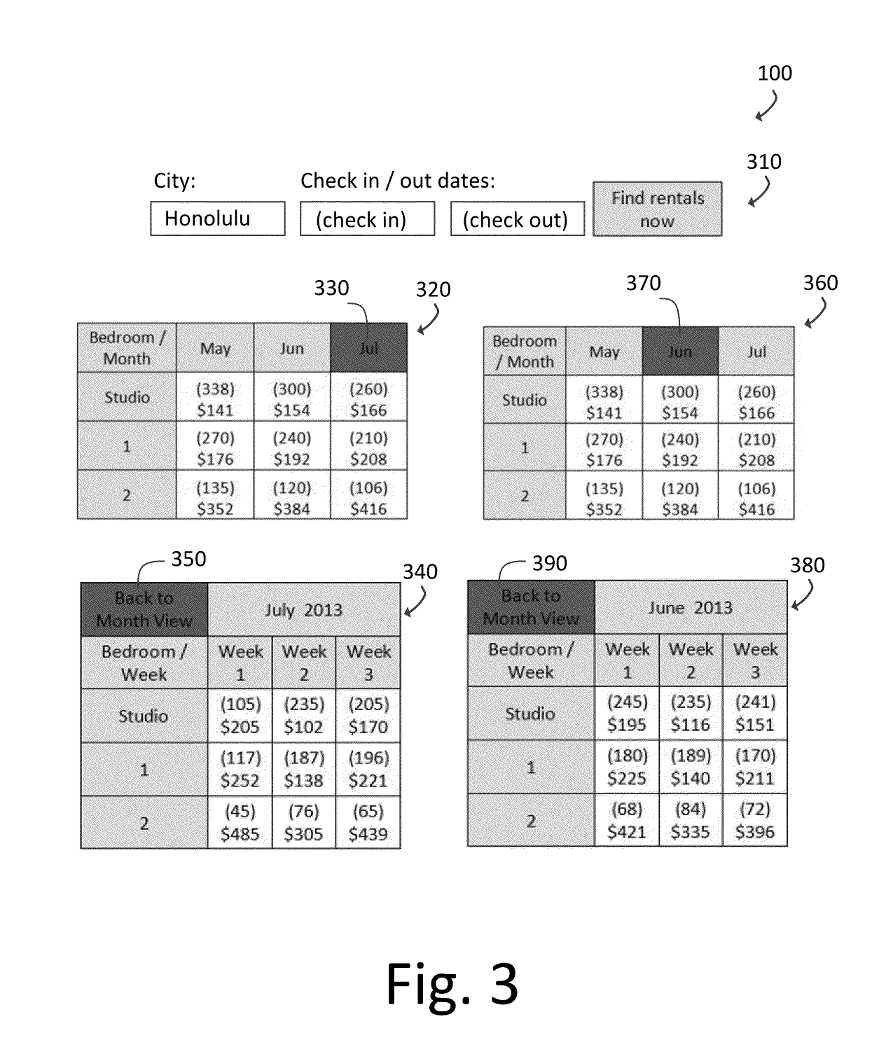

FIG. 3 illustrates a drilling feature of the system 100 according to an embodiment of the invention. The system 100 has a search engine 310 (like the search engine 110), a first grid of cells 320, a second grid of cells 340, a third grid of cells 360, and a fourth grid of cells 380. Each of the grid of cells 320, 340, 360, 380 illustrate only a limited number of months, weeks, and bedrooms to more clearly focus on the drilling down and up feature. The system 100 has a drilling down and up feature that allows the traveler to go back and forth between monthly and weekly grids views.

The first grid of cells 320 displays three bedroom options over three months. To drill down, a first selection 330 selects the month of July. In another embodiment, the first selection 330 selects any of the four cells in this column to drill down to the weeks in July. The first selection 330 drills down from the month based view 320 to the week based view 340.

The second grid of cells 340 displays three bedroom options over the first three weeks of July. To drill back up, a second selection 350 takes the traveler back to the month based view 360. One with skill in the art could design a different arrangement for going back and forth between two web pages without departing from the scope of the invention. For example, the traveler could use a browser's back button.

The third grid of cells 360 shows the same data as the first grid of cells 320. Similar to the first selection 330, to drill down again, the third selection 370 selects the month of June, drills down from the month based view 360 to the week based view 380.

The fourth grid of cells 380 displays three bedroom options over the first three weeks of June. Similar to the second selection 350, to drill up again, the fourth selection 390 takes the traveler back to the month based view 360.

This drilling feature advantageously allows a traveler to quickly and easily view vacation rentals based on different periods of time. The traveler can drill down from a particular month to a particular week, or vice a versa, to view the availability and prices for that period of time.

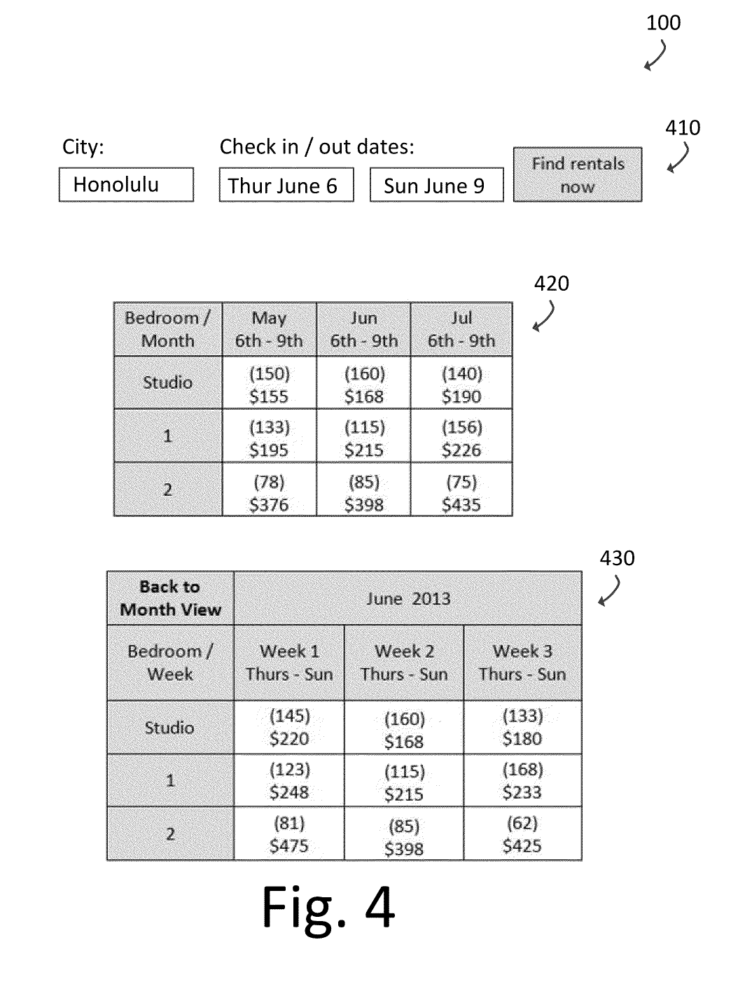

FIG. 4 illustrates a day matching feature of the system 100 according to an embodiment of the invention. The system 100 has a search engine 410 (like the search engine 110), a monthly grid of cells 420 and a weekly grid of cells 430. Each grid of cells 420 and 430 illustrate only a limited number of months, weeks, and bedrooms to more clearly focus on the day matching feature.

The system 100 illustrates the day matching feature to match days of a month (e.g., 6th through 9th) between several months in the monthly grid view and days of a week (e.g., Thursday through Sunday) between several weeks in the weekly grid view.

The monthly grid of cells 420 displays three bedroom options over three months. In this example, the desired stay is from Thursday, June 6th through Sunday, June 9th. As such, the day matching feature allows each column to maintain the desired days per month (the 6th-9th) in the monthly grid view 420. The availability and prices refer only to the desired days of the month. If the traveler drills down to the weeks of June, the weekly grid of cells 430 displays three bedroom options over three weeks. Again, the availability and prices refer only to the days of the week desired (e.g., Thursday through Sunday).

In one embodiment, the availability and price include only places that have availability over the entire check in/out range. In another embodiment, the availability and price include only places that have availability over less than the entire check in/out range.

This matching feature is beneficial for a person who typically vacations on certain times of month (e.g., first week of the month) or on certain days per week (e.g., Thursday through Sunday). By matching the days, the traveler gets an apples to apples comparison of the average nightly prices of different months or weeks.

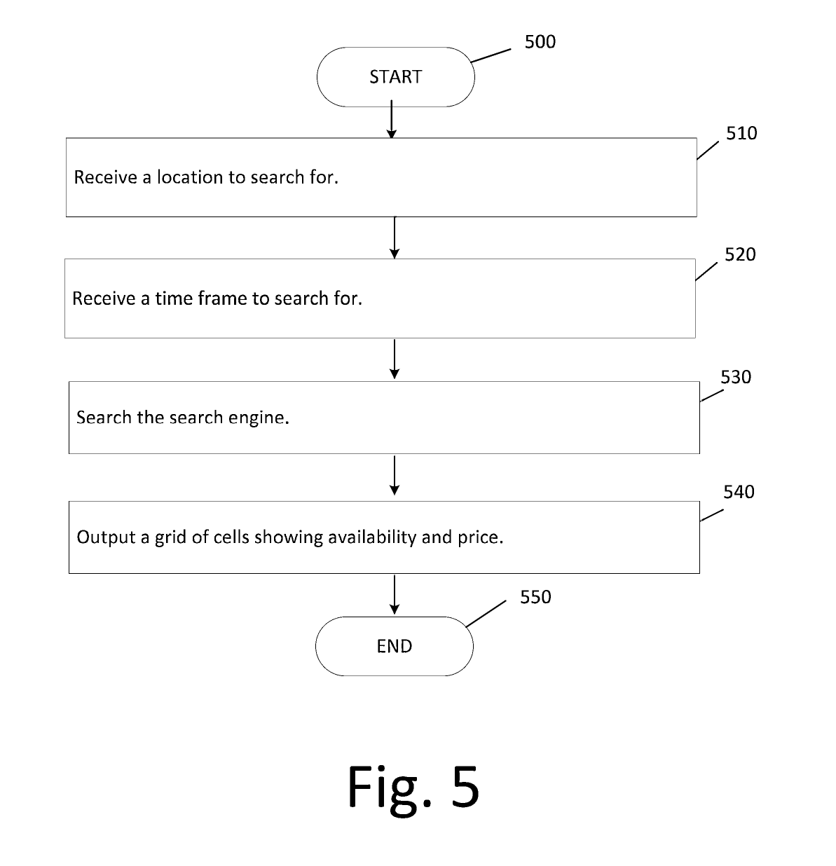

FIG. 5 illustrates the process of using the system 100 according to an embodiment of the invention. The process starts at step 500. At step 510, the system 100 receives a location to search for. In one embodiment, the system 100 is configured to receive any major city in the world. At step 520, the system 100 receives a time frame to search for. In one embodiment, the time frame is the travelers desired travel dates. The traveler hits the search button and the system searches the search engine 110 at step 530. At step 540, the system 100 outputs a grid of cells showing the availability and price based on a period of time and a number of bedrooms. The grid of cells can be a monthly grid 120 or a weekly grid 220. The process may be repeated recursively a number of times and ends at step 550.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
a search engine, the search engine searching a vacation rental database based on a location and a time frame;
an initial plurality of cells comprising rows and columns, wherein the initial plurality of cells comprising a number of bedrooms in the rows or columns and a period of time in the rows or columns, wherein the period of time per row or column is greater than one day;
a first cell in the initial plurality of cells, the first cell based on a first number of bedrooms and a first period of time, wherein the first cell comprises a first price corresponding to one or more vacation rental properties in the first cell; and
a second cell in the plurality of cells, the second cell based on a second number of bedrooms and a second period of time, wherein the second cell comprises a second price corresponding to one or more vacation rental properties in the second cell, wherein the second cell comprises a different number of bedrooms or a different period of time than the first cell.

2. The system of claim 1, wherein clicking a cell drills down to a subsequent plurality of cells comprising rows and columns, the subsequent plurality of cells having a shorter period of time.

3. The system of claim 2, wherein clicking the cell drills down from a monthly period of time to a weekly period of time.

4. The system of claim 1, wherein clicking a cell drills up to a subsequent plurality of cells comprising rows and columns, the subsequent plurality of cells having a longer period of time.

5. The system of claim 4, wherein clicking the cell drills up from a weekly period of time to a monthly period of time.

6. The system of claim 1, wherein the search engine comprises fields for a check in date and a check out date.

7. The system of claim 6, wherein days of a month in the check in date and the check out date match the first period of time and the second period of time.

8. The system of claim 6, wherein days of a week in the check in date and the check out date match the first period of time and the second period of time.

9. The system of claim 1, wherein the number of bedrooms in the rows or columns comprises a studio, a one bedroom, a two bedroom, a three bedroom, a four bedroom, a five bedroom, or a six bedroom.

10. The system of claim 1, wherein the period of time in the rows or columns comprises a month.

11. The system of claim 1, wherein the period of time in the rows or columns comprises a week.

12. The system of claim 1, wherein the first price and the second price comprise the average nightly rate.

13. A method comprising:
receiving a location to search for vacation rentals in a search engine;
receiving a time frame to search for vacation rentals in the search engine;
searching the search engine;
displaying a first cell in a plurality of cells having rows and columns, the first cell based on a first number of bedrooms and a first period of time greater than one day, wherein the first cell comprises a first price corresponding to one or more vacation rental properties in the first cell; and
displaying a second cell in the plurality of cells, the second cell based on a second number of bedrooms and a second period of time greater than one day, wherein the second cell comprises a second price corresponding to one or more vacation rental properties in the second cell, wherein the second cell comprising a different number of bedrooms or a different period of time than the first cell.
